(19) United States
(12) Patent Application Publication
(10) Pub. No.: US 2006/0285916 A1
(43) Pub. Date: Dec. 21, 2006

(54) Pivotal device

(75) Inventors: Sheng-Nan Lu, Shulin City (TW); Jia-Hao Hsu, Shulin City (TW)

Correspondence Address: CHARLES E. BAXLEY, ESQ., 90 JOHN STREET, THIRD FLOOR, NEW YORK, NY, 10038, US

(73) Assignee: Shin Zu Shing Co., Ltd.

(21) Appl. No.: 11/396,756

(22) Filed: Apr. 3, 2006

(30) Foreign Application Priority Data
Jun. 20, 2005 (TW) 094210312

(51) Int. Cl. F16C 11/00

(52) U.S. Cl. 403/119

(57) ABSTRACT

A pivotal device has a sleeve and a shaft. The sleeve has at least one notch defined in the sleeve. The shaft has two opposite plane surfaces formed on the shaft and two arcuate surfaces formed respectively on the shaft adjacent to the corresponding plane surfaces whereby the arcuate surfaces selectively engage the at least one notch. The sleeve is mounted securely on a chassis of a laptop. The shaft is mounted securely on a cap of the laptop. When the cap is rotated relative to the chassis, the shaft is rotated relative to the sleeve. The notch engages one of the arcuate surfaces so the cap is closed without collision.

### BACKGROUND OF THE INVENTION

1. Field of the Invention

The present invention relates to a pivotal device, and more particularly to a pivotal device that can stably position a cap of a device on a chassis of the device and prevents the cap from colliding with the chassis of the device.

2. Description of the Related Art

A conventional pivotal device has a sleeve and a shaft. The sleeve has a first protrusion and the shaft has a second protrusion corresponding to the first protrusion. The shaft is inserted into the sleeve. The sleeve is mounted securely on a chassis of a device and the shaft is mounted securely on a cap of the device. The cap can rotate relative to the chassis via the shaft rotating relative to the sleeve. The first protrusion abuts the second protrusion to limit the rotating angle of the cap. However, the cap cannot position relative to the chassis stably and is easy to collide with the chassis when the cap is closed.

Therefore, the invention provides a pivotal device to mitigate or obviate the aforementioned problems.

### SUMMARY OF THE INVENTION

The main objective of the present invention is to provide a pivotal device which can stably position a cap of a device on a chassis of the device and prevent the cap from colliding with the chassis when the cap is closed.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a pivotal device in accordance with the present invention;

FIG. 2 is an exploded perspective view of the pivotal device in FIG. 1;

FIG. 3 is a cross-sectional view of the pivotal device in FIG. 1 when a first portion is expanded;

FIG. 4 is a cross-sectional view of the pivotal device in FIG. 1 when xxx; and

FIG. 5 is a perspective view of the pivotal device in FIG. 1 in usage.

### DETAILED DESCRIPTION OF THE PREFERRED EMBODIMENT

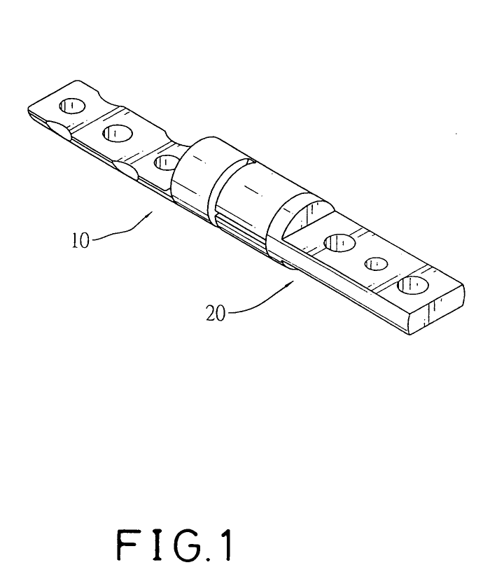

With reference to FIG. 1, a pivotal device in accordance with the present invention comprises a sleeve (10) and a shaft (20).

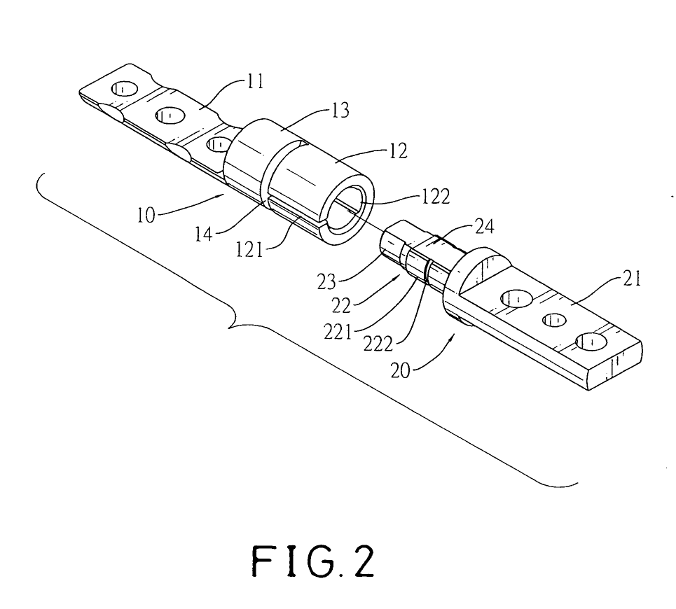

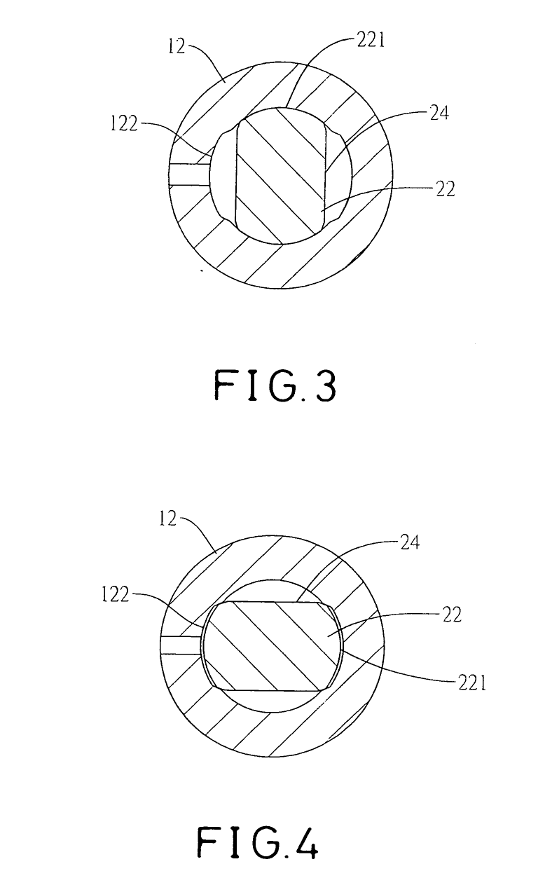

With further reference to FIGS. 2 and 3, the sleeve (10) has a first fastener (11) extending out of a first end of the sleeve (10), a first portion (12) formed in a second end of the sleeve (10), and a second portion (13) formed between the first portion (12) and the first fastener (11). The first and second portions (12, 13) are hollow. A gap (14) is defined radially in the sleeve (10) and between the first portion (12) and the second portion ( 13). A slot (121) is defined axially in the first portion (12). Two notches (122) are opposite to each other and are defined respectively in two opposite inner sides of the first portion (12).

The shaft (20) has a second fastener (21) formed in a first end of the shaft (20) and a bar (22) formed in a second end of the shaft (20). A head (23) is formed axially on and extends out from a free end of the bar (22). The bar (22) and the head (23) respectively have two opposite plane surfaces (24) formed on the bar (22) and the head (23). Two arcuate surfaces (221) are formed respectively on the bar (22) and are adjacent to the corresponding plane surfaces (24). Two channels (222) are defined respectively in the arcuate surfaces (221).

The bar (22) is mounted rotatably into the first portion (12) and the head (23) is mounted in the second portion (13). An outer diameter of the bar (22) is slightly bigger than an inner diameter of the first portion (12) so that the first portion (12) is slightly expanded via the slot (121). The first portion (12) partially connects to the second portion (13) so that the second portion (13) is not expanded and is not distorted. With further reference to FIG. 4, when the arcuate surfaces (221) respectively engage the notches (122), the first portion (12) resumes to its original status.

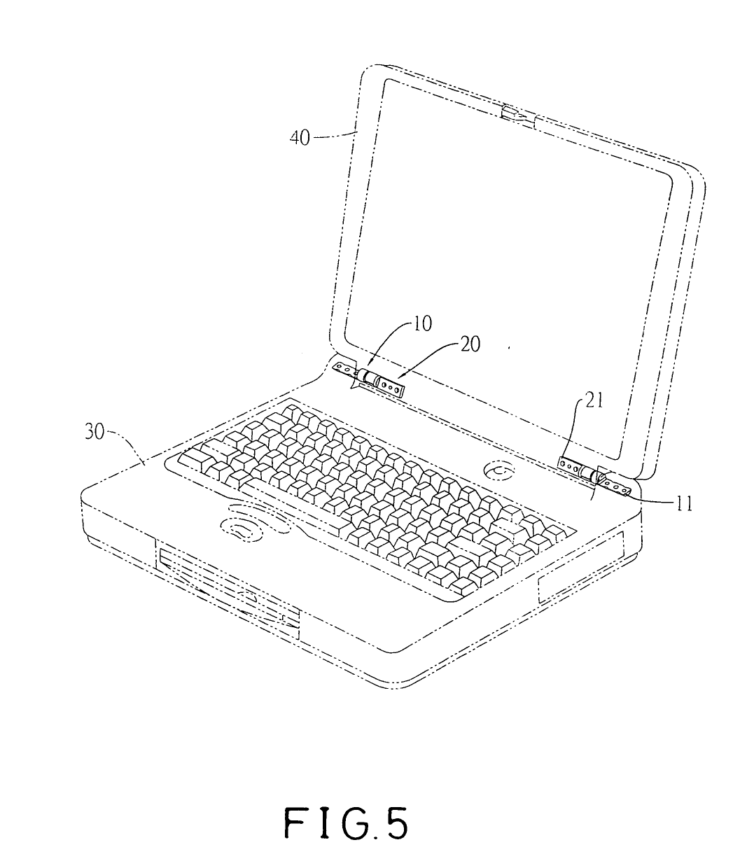

With further reference to FIG. 5, the first fastener (11) is mounted securely in a chassis (30) of a laptop. The second fastener (21) is mounted securely in a cap (40) of the laptop. The cap (40) is rotated relative to the chassis (30) to rotate the shaft (20) relative to the sleeve (10). When the notches (122) of the sleeve (10) engage the arcuate surfaces (221) of the shaft (20), the cap (40) is closed relative to the chassis (30) without collision. The bar (22) is slightly bigger in the outer diameter than the inner diameter of the first portion (12) so that the friction is occurred when the shaft (20) rotates relative to the sleeve (10). Then the cap (40) can be stably positioned on the chassis (30) at a desired angle.

It is to be understood, however, that even though numerous characteristics and advantages of the present invention have been set forth in the foregoing description, together with details of the structure and function of the invention, the disclosure is illustrative only. Changes may be made in details, especially in matters of shape, size, and arrangement of parts within the principles of the invention to the full extent indicated by the broad general meaning of the terms in which the appended claims are expressed.

What is claimed is:

1. A pivotal device comprising:
a sleeve having
a first fastener formed on and extending out of a first end of the sleeve;
a hollow first portion formed on a second end of the sleeve and having
at least one notch defined in an inner wall of the first portion; and
a hollow second portion formed between the first fastener and the first portion; and
a shaft rotatably connected with the sleeve and having
a second fastener formed in a first end of the shaft;
a bar formed in a second end of the shaft and mounted rotatably in the first portion of the sleeve; and
a head formed axially on and extending out from in a free end of the bar and mounted in the second portion of the sleeve and having an outer diameter bigger than an inner diameter of the first portion of the sleeve;
wherein the bar and the head respectively have two opposite plane surfaces formed on the bar and the head, two arcuate surfaces are formed respectively on the bar and are adjacent to the plane surfaces, whereby the arcuate surfaces selectively engage the at least one notch.

2. The pivotal device as claimed in claim 1, wherein a gap is defined radially in the sleeve and is between the first portion and the second portion of the sleeve, a slot is defined axially in the first portion of the sleeve, and a channel is defined radially in the bar of the shaft.
